(19) United States
(12) Patent Application Publication
(10) Pub. No.: US 2005/0029346 A1
(43) Pub. Date: Feb. 10, 2005

(54) Communication system

(76) Inventors: David Vincent Byrne, Dublin (IE); Eamonn Heffernan, Cork (IE)

Correspondence Address: JACOBSON HOLMAN PLLC, 400 SEVENTH STREET N.W., SUITE 600, WASHINGTON, DC, 20004, US

(21) Appl. No.: 10/931,967

(22) Filed: Sep. 2, 2004

Related U.S. Application Data
(63) Continuation of application No. PCT/IE03/00033, filed on Mar. 4, 2003.

(30) Foreign Application Priority Data
Mar. 5, 2002 (IE) 2002/0168
Apr. 30, 2002 (IE) 2002/0322

(51) Int. Cl. G06K 5/00

(52) U.S. Cl. 235/382

(57) ABSTRACT

An airport communication system (1) has a tag (10) affixed by a clip (12) to each passenger en route between check-in and boarding. Each tag (10) transmits an identifier on a particular RF channel with a short range, and the location of a transponder (5) which received the transmission indicates passenger location. A server (4) correlates tag and passenger identifiers and generates alerts if alert conditions are met such as excessive distance from a boarding gate at a particular time.

### FIELD OF THE INVENTION

The invention relates to a system and method for communication of information with passengers in an airport, train station or other passenger terminus.

### PRIOR ART DISCUSSION

At present when a passenger checks in at the check-in desk of an airport, he is given a boarding card, and his baggage is tagged and sent for delivery to the plane hold. On arrival at the departure gate, the passenger offers his ticket for inspectior/cancellation and boards the plane.

In between these two events, neither the airport nor the airline has any clear information of the location of the passenger. The only way to contact a passenger is via a public address announcement, in the hope that the passenger will hear and respond as directed.

Passengers who present themselves in an untimely manner at the departure gate cause considerable problems for the airline and the airport. Airport staff are tied up making announcements, looking for people, or waiting for departure gates or aeroplane stands to become free. Airlines may miss early takeoff opportunities and may miss their assigned takeoff slot entirely causing late takeoff, late arrival and subsequent knock-on schedule effects. Late passengers cost airlines fuel, time, schedule and money.

Under modern security regimes, any non-traveller's baggage must be removed from the aircraft before takeoff. Since the airline can only distinguish between late and non-travellers at the last moment, the baggage must be searched for and removed from the plane after gate closure, causing further delay to the aircraft.

Also, a person can check in, send baggage to the hold, then walk out of the airport, with no notification either to the airline or the airport. Again, the problem will not be detected until gate closure when it is too late to avoid delay to the aircraft, which must now unload the non-traveller's baggage.

Passengers going through security checks may experience queuing delays. Without any system of notification, passengers who should be queuing may not be aware of the delays and may be unwittingly in danger of missing their flight.

United States Patent Application No. US2001/0016823 and Japanese published specification no. JP2001086539A2 describe systems in which information is transmitted wirelessly to passengers. However, this does not solve the core problem of the airport or airline not being aware of locations of the passengers.

The invention is therefore directed towards providing an improved communication system for airports or other passenger terminals.

### SUMMARY OF THE INVENTION

According to the invention, there is provided a portable passenger tag comprising:
a wireless transmitter; and
a controller for causing a passenger identifier to be transmitted by the wireless transmitter.

In one embodiment, the transmitter transmits over a range of less that 200 m.

In another embodiment, the transmitter transmits over a range of less than 100 m.

In a further embodiment, the tag further comprises a receiver, and the controller processes received data.

In one embodiment, the receiver and the transmitter are incorporated in a transceiver.

In another embodiment, the tag comprises a connector for affixing to a passenger garment.

In a further embodiment, the connector is a clip.

In one embodiment, the tag further comprises a sensor for detecting if the device is affixed to a person, and the controller comprises logic to transmit status information indicating whether the tag is affixed to a person.

In another embodiment, the circuit logic transmits status information only by exception, an exception being if the tag is not affixed to a person.

In a further embodiment, the sensor is a temperature sensor.

In one embodiment, the transmitter transmits on one of a plurality of possible frequency channels and comprises means for being dynamically configured with a channel selection upon each use.

In another embodiment, the controller comprises logic for storing passenger boarding card data, and a security lock to prevent unauthorised editing of the boarding card data.

In a further embodiment, the controller comprises logic for storing a passenger biometric as part of the boarding card data and an output interface for outputting biometric data.

In one embodiment, the biometric is a digital photograph.

In another embodiment, the controller comprises an erasing function for erasing all passenger-specific data upon receipt of a deactivation command.

In another embodiment, the controller monitors received time slot data and directs transmission by the wireless transmitter only in an allocated time slot.

In a further embodiment, the controller directs transmission and reception in a cycle and powers down between cycles.

In one embodiment, the duty cycle is less than 1%.

In another aspect, the invention provides a passenger terminus communication system comprising:
a function in a check-in system for activating a tag of any preceding claim;
a plurality of transponders for receiving passenger identifiers transmitted by said tags;
a processor for receiving the identifiers from the transponders and for correlating them with passenger data, and for generating an alert if an alert condition is satisfied.

In one embodiment, the processor determines passenger location on the basis of which transponder received a passenger's tag transmission.

In a further embodiment, the processor is in a server connected to the transponders via a network.

In one embodiment, the transponders transmit data to the tags.

In another embodiment, each transponder transmits data immediately in response to receiving a transmission from a tag.

In a further embodiment, each transponder allocates a time slot to each active tag, and indicates the time slot in each reply.

In a further embodiment, the tags and the transponders transmit at mutually different frequencies.

In one embodiment, the transponders have a substantially longer transmission range than the tag transmitters.

In another embodiment, the check-in function writes boarding card data to the tags, and the system further comprises a boarding gate function for reading said data and for de-activating the tags.

In a further embodiment, the check-in function comprises an interface for delivering a biometric of a passenger to the processor, and the boarding gate function comprises an interface for receiving and outputting the biometric.

In one embodiment, the biometric is a photograph.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a schematic diagram illustrating a communication system of the invention; and

FIGS. 2 to 6 are views of a tag of the system.

### DESCRIPTION OF THE EMBODIMENTS

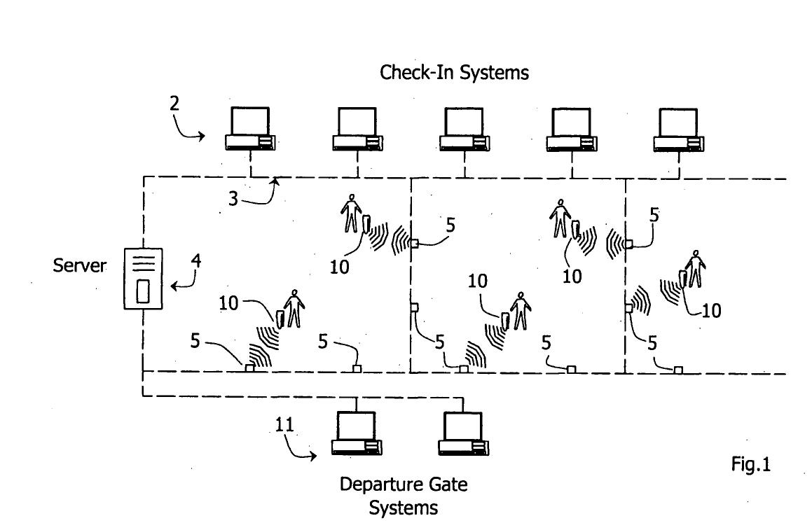

Referring to FIG. 1 a communication system 1 comprises:
functions in airline check-in systems 2;
a local area network 3;
a communications server 4;
transponders 5 located around the airport;
functions in departure gate systems 11; and
portable communication devices (“tags”) 10 affixed to passengers.

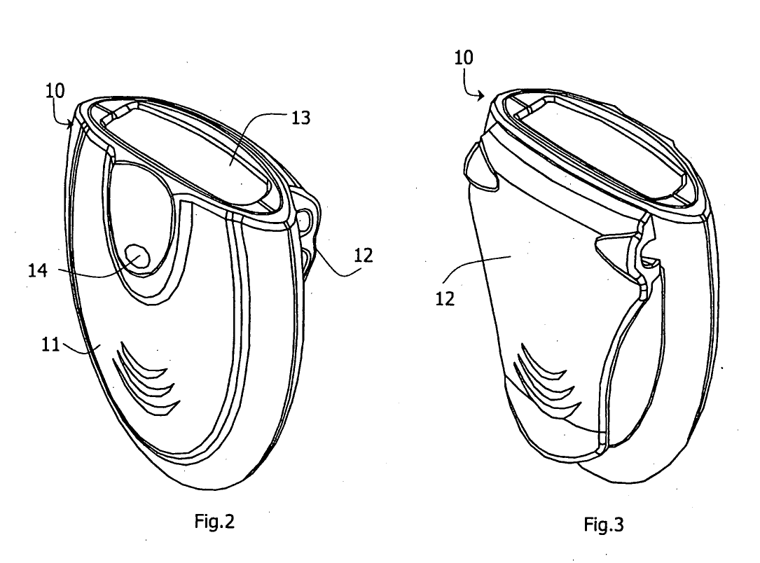

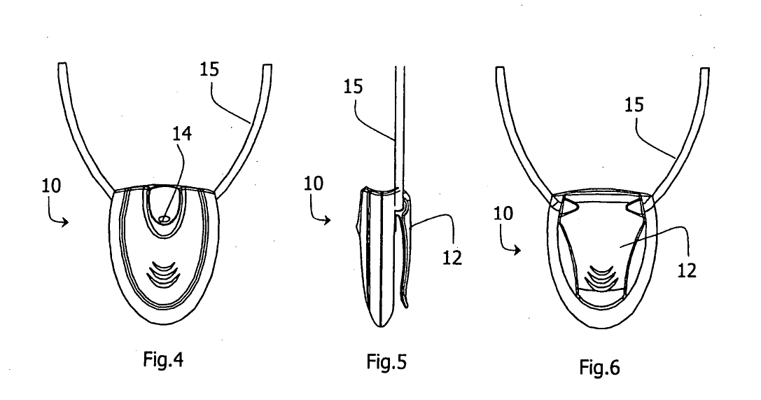

Referring to FIGS. 2 to 6, each tag 10 comprises a housing 11 and an integrally moulded clip 12 for connecting to a garment pocket or lapel for example. The tag 10 comprises a communication circuit within the housing 11 driving an LCD display 13 and an audible beeper 14. It will be appreciated from FIGS. 2 to 6 that the tag 10 is compact and streamlined in configuration for convenient carrying in an airport.

The tag 10 acts as a combined locating device for airport/airline personnel, as an information device for the passenger, and as an electronic “boarding card”. When a passenger checks in for a flight a check-in system 2 transmits via the local area network 3 data concerning the passenger, the passenger's booking, and the tag allocated to the passenger. The server 4 maintains a database of records, the records having an active life cycle between checking-in and boarding only. The tag data includes a unique identifier for the tag and a frequency channel for transmission over a short range. This identifier is referred to as a “tag identifier”, however it is essentially a passenger identifier as it is directly linked with the passenger record in the server 4. The tag 10 is capable of transmission over a range of different discrete channels, only one channel being selected on a use-by-use basis. In one embodiment, the channel is selected according to the particular flight in order to avoid interference between tags of different passengers as they are in relatively close proximity to each other. The information which is transmitted includes the tag's identifier. The transmissions are intermittent, being picked up by the closest transponder 5. The transponder 5 in turn generates a data packet for the server indicating the tags in its proximity. In another embodiment, the tag incorporates a temperature, IR, or other proximity sensor to determine if the tag is being worn by the passenger. The tag circuit generates an exception event alert if it senses that it is not being worn. Therefore, the server 4 can generate an alert for airline or airport personnel at an early stage.

Each transponder 5 transmits information of value to the passengers, including flight delay information. It also transmits alerts requesting the passenger to contact staff for any particular reason.

At the boarding gate the passenger gives the tag 10 to the boarding staff, who deactivate it by transmitting a wireless security code. The boarding gate system 11 transmits a deactivation message to the server 4, which updates its database and marks the passenger's record as inactive.

The information captured in real time by the server 4 allows staff to dynamically receive alerts according to configurable conditions including:
a passenger being greater than a set distance from the boarding gate a short duration before boarding, and
a tag not being affixed to a passenger.

In response to these alerts the staff can directly communicate with the allocated tag in a direct “one-to-one” link without need for making a general announcement over the speaker system. Of course, if the tag is not being worn by the passenger for some reason there can be no direct communication. However, the staff still have the advantage of being warned at an early stage because of the proximity sensor on the tag 10.

The following describes the system 1 in more detail.

Tag 10

The tag is a lightweight portable device which is fixed to each passenger at check-in. The tag is battery-powered, has a CPU, an RF transceiver, a small LCD screen 13 to display information updates, a multicolour LED 14 which can indicate status, and a beeper which can alert the passenger.

The tag transceiver has a fixed short range radio footprint, so that transmissions are detectable for only a limited number of metres. The range is below 200 m, and preferably below 100 m. This restricts pick-up of the tag transmissions only to the nearest transponder 5, thereby indicating location of the passenger in a very simple manner.

Each tag has a unique 20-bit (giving c. 1 million permutations) identity number [ID] assigned to it at manufacture or at commissioning. The tag transmits only its ID in normal circumstances, thus minimising transmission time. The linkage between a tag and a passenger is established at check-in and is maintained on the server 4 until it has passed through the departure gate.

The mechanical clip 12 ensures that the tag is securely fastened to the passenger, but is removable. In the embodiment in which the tag includes a proximity sensor to determine if it is being worn, this would be incorporated in the clip. In this embodiment, the CPU is programmed to transmit code bits with the tag ID to indicate an alarm condition. In this manner, if a tag is removed or discarded, an alert is raised.

The RF transceiver in the tag receives on one of a specific set of frequency channels and transmits on one of another set of channels. In one embodiment, the allocated waveband is divided into ten channels, and tags transmit on odd-number channels, and receive on even-number channels. This ensures that tag ID traffic does not interfere with the ability of the transponder to transmit status/alerts to any given tag. In addition, the distribution of tags across multiple channels reduces the probability of collisions (more than one tag attempting to transmit at the same time), because the population per channel is reduced to the number of active tags divided by the channel count. Tags for a specific flight are assigned incrementing channel numbers on check-in so that high concentration areas such as the departure gate would not be flooded with same-channel tags.

The RF transceiver is the heaviest power consumer on the tag. Therefore it is desirable to switch it off whenever possible to extend battery life. The RF protocol facilitates this. Each tag is programmed to transmit in a particular time slot every second and to immediately open a reception window after each transmission. The transponder 5, on receipt of a tag ID immediately responds to the tag during the brief reception window. This means that both the tag transmitter and receiver are off for most of the one-second interval, approximately 999 milliseconds. The low duty cycle of c. 0.1% minimises power consumption and reduces the size of battery required.

Another feature of the RF protocol is time-slot allocation, briefly alluded to above. As part of the transponder response, each tag in a transponder cell is given a time-slot for future transmissions within the cell. In this manner, the pool of tags within a cell are progressively marshalled into non-competing time-slots, so collisions and contention are minimised. This process takes about one second, which is the normal transmit interval.

Another feature of the tag is the ability to detect Received Signal Strength Indication (RSSI) on the transmit channel, as well as on the receive channel. This indicates if a nearby tag is already transmitting on the same channel.

It will be appreciated that the operation of the transceiver and transponder avoid interference by virtue of (a) distribution of tags across multiple channels, (b) time-slot allocation, and (c) the fact that the transmission range is short. Also, the short duty cycle ensures power consumption is minimised.

The battery is a rechargeable type, to minimise the size of the battery and to extend the useful life of the product.

The tag 10 is constructed from a lightweight plastics material. The battery forms a significant part of the total package, and is specifically designed to suit the tag, in terms of voltage, current and physical size. In fact, the other elements of the package may well be fixed directly to the battery (i.e. the battery may act as the PCB also). The CPU, RF transceiver and LCD driver are manufactured as a single chip to minimise component count and interconnect issues, as well as reducing space. The chip is delivered in die-form, which is fixed to the PCB, again to reduce space. The LCD display 13 and the LED 14 provide visual indication of status. A piezo-electric transducer provides audio indication of an alert. Charging and programming points are brought to the case surface.

The RF metrics in the Table below demonstrate that a large population of tags can be accommodated on a single transmit frequency without excessively high data rates (order of 100 kbps). Therefore, there is no need to move up to very high frequencies (>2 GHz) where power consumption is higher.

The tags could operate in the recognised licence-free Instrument, Scientific, Medical bands [ISM], such as 434 MHz, 868 MHz (Europe), 2.4 GHz, 915 MHz (USA). However, since anyone is entitled to use these bands, it would be preferable if special wavebands were allocated to the project on a world-wide basis. This would have the advantage of securing the allocated bands for this purpose, ensuring no third-party interferers obstruct system performance and it would allow a single tag to be used world-wide.

Airport X

| | | | |
|---|---|---|---|
| Plane | Per hour | 60 | Plane departs every minute - no |
| departures | | | need to concern ourselves with |
| | | | arrivals. |
| Passengers | People | 300 | Full plane load. |
| per plane | | | |
| Maximum | People/hr. | 18000 | Maximum departure volume per |
| throughput | | | hour |
| Terminals | | 4 | |
| Duration | Hours | 2 | Assume people spend on |
| Check-Gate | | | average 2 hours from CheckIn to |
| | | | Gate |
| Average | People | 36000 | Airport passenger population |
| population | | | |
| Average | People | 9000 | Terminal passenger population |
| Terminal | | | |
| Population | | | |
| Need a | Tags | 10000 | System must handle a minimum |
| minimum | | | of 10 k active tags. |
| system | | | |
| capacity of | | | |
| Design | Tags | 20000 | Design system for 20 k to handle |
| capacity | | | peaks, delays etc. |
| Transponders | | 250 | Assume a terminal is divided |
| per terminal | | | into 250 cells of in-range, |
| | | | transponder regions |
| People per | | 80 | Average people in a transponder |
| transponder | | | cell |
| (avg) | | | |
| Peak pax per | | 400 | High concentration of people at |
| transponder | | | gate prior to departure |
| Design | Tags | 800 | |
| capacity per | | | |
| transponder | | | |
| Update interval | seconds | 1 | Interval between tag |
| | | | transmissions |
| Total | /second | 800 | Number of active tags × Tag |
| transmissions | | | Transmit Interval |
| Max | uS | 1250 | Window allowed for each |
| transmission | | | transmission. |
| window | | | |
| Efficiency due | | 25% | Assume only 1 in 4 gets through |
| to collisions etc | | | (very conservative) |
| Adjusted | uS | 312.5 | Window must shorten to allow |
| transmit | | | for inefficiencies |
| window | | | |
| Tag Packet | Bits | 32 | Allows 16 million ID codes and 8 |
| Length | | | check bits. |
| Bit rate | kBits/Sec | 102.4 | This bitrate is attainable in 434, |
| | | | 868, 915 MHz bands as well |

Transponder Network 5

Each transponder 5 consists of an RF transceiver and a network adapters which acts as a bridge between the tags 10 and the computer network 3, which in turn connects to the server 4. The transponders 5 have an asymmetric transmit-receive capability compared to tags, (i.e. transponder transmissions are more powerful than tag transmissions), so that tags can be reached over longer ranges. This is important to ensure the integrity of the alert function. The transponder transmits commands (status/alerts) to the tags in response to tag ID transmissions.

The RF transceiver in each transponder 5 can transmit and receive simultaneously on alternate channels, in this embodiment the even channels of the full channel set. Each transponder replies to a tag ID transmission using the next channel. For example, if a tag transmits on channel number three, the transponder replies on channel number four.

In an alternative embodiment, high bandwidth transceivers (order of 1 Mbps datarate) are employed in the transponders, thus avoiding the need for channelisation since transmission windows are short. However, high data rates require high carrier frequencies (order of 2 GHz), and higher frequencies mean higher current consumption.

Server 4

The server 4 acts as a networked data-store which connects a tag ID to a particular passenger. The server stores all passenger details indexed with the assigned tag ID. The server 4 allows many clients to access or update its information. The location of each tag within the transponder network is also maintained on the server 4. As each transponder 5 receives tag IDs, it sends its current population to the server. Because tag IDs are short (order of 32 bits-4 bytes), a large population can be sent in a relatively short packet over the high-speed transponder network to the server 4.

The server also stores a biometric for a passenger cross-referenced to the tag ID. In this embodiment, the biometric is a photograph, however, it may alternatively be a fingerprint or a voiceprint. The biometric is captured at passenger booking or check-in, and may be retrieved by any authorised node on the network, such as a departure gate system 11. In practice, this means that boarding personnel have immediate access to important biometric information for security purposes to authorise passengers for boarding. This is very helpful for improving security.

Check-In Desk Systems 2

The check-in desk initiates the process of establishing the link between a tag 10 and a passenger. The check-in staff process the passenger in the normal manner. As part of the check-in process, a tag 10 is automatically assigned to that passenger, and the tag ID and passenger data are sent to the server 4. Additional security measures can also be taken at this point. For example, a digital photo could be taken of the passenger and transmitted to the server at the check-in point.

The tag 10 also carries the information normally carried on a boarding card. This means that printed boarding cards can be dispensed with. The seat number allocated to the passenger can be printed on the baggage tag or on a label to be affixed to the passenger's travel documents. Alternatively, paper labels can be dispensed by storing seat and flight data in the tag's circuit, and the circuit displaying the data on the LCD 13.

Departure Gate System 11

At the gate as passengers gather to board the plane the transponders in the vicinity of the gate maintain an instantaneous census of the population of passengers within the area. This census is continually transmitted to the server 4. A client terminal at the gate allows gate staff to monitor the state of completion of their passenger list. Reporting can be done by exception so that gate staff concentrate only on those missing from the immediate gate area.

As boarding begins, the system 11 deactivates each tag. As each tag is handed in, the passenger's digital photo is displayed at the terminal to provide visual proof of identity (which may have been established with passport or ID at the check-in desk). The passenger is marked as onboard. The passenger can be reminded of his or her seat number out at this point if required. This can be done by electronic display or printed ticket or label.

It will be appreciated that the invention achieves the benefit of passengers being individually and automatically updated of flight and gate status without intervention of airport staff. Passengers are individually and automatically alerted based on their expected travel time from their current location to gate and more distant passengers can be selectively alerted to begin proceeding to the gate. Also, passengers who are at the wrong departure area can be immediately alerted to the fact. Passengers who are too far from the gate area to make the gate by closure time can be eliminated from travelling, and their baggage removed long before gate closure and cargo loading, thereby eliminating a major element of aircraft delay. Similarly, walk-outs from the check-in area or departure lounge cause automatic alerts which can inform airline, airport and security staff. Also, tags which are removed or discarded by passengers automatically trigger security alerts.

The system 1 gives an early indication of late or non-travelling passengers, long before gate closure, so that non-travelling baggage can be prevented from loading. Another advantage is that no PA announcements are required to track or locate passengers. Boarding cards can be dispensed with, thereby saving time and problems caused by lost boarding cards. If a tag comes loose from a passenger's clothes it can be located immediately. Security can be enhanced since all passengers are continually tracked. Security staff who wish to locate an individual can download the photo to a hand-held unit and proceed immediately to the passenger's current transponder cell, where visual identification is facilitated by the photo, current location, and the tag display.

The system provides airport management with a constant accurate survey of passenger movement which can help the authorities to streamline usage of facilities, shops, and other features of the airport.

The invention is not limited to the embodiments described but may be varied in construction and detail. For example, it is envisaged that a biometric may alternatively be stored in a tag. Also, instead of determining location on the basis of which transponder “hears” a tag, it may alternatively or additionally be determined on the basis of triangulation such as in mobile network base station to mobile station communication. It is also envisaged that the tag may not have receive capability, only transmitting its identifier to provide real time passenger location information and an indication if it is not being worn.

Furthermore, it is envisaged that the server and/or the check-in function and/or the boarding function may be centrally hosted on a remote server accessed via the internet or an intranet. Also, the tag and the system may alternatively be used in other passenger terminals such as in bus or train stations.

1. A portable passenger tag comprising:
a wireless transmitter; and
a controller for causing a passenger identifier to be transmitted by the wireless transmitter.

2. The portable passenger tag as claimed in claim 1, wherein the transmitter transmits over a range of less that 200 m.

3. The portable passenger tag as claimed in claim 2, wherein the transmitter transmits over a range of less than 100 m.

4. The portable passenger tag as claimed in claim 1, wherein the tag further comprises a receiver, and the controller processes received data.

5. The portable passenger tag as claimed in claim 4, wherein the receiver and the transmitter are incorporated in a transceiver.

6. The portable passenger tag as claimed in claim 1, wherein the tag comprises a connector for affixing to a passenger garment.

7. The portable passenger tag as claimed in claim 6, wherein the connector is a clip.

8. The portable passenger tag as claimed in claim 1, wherein the tag further comprises a sensor for detecting if the device is affixed to a person, and the controller comprises logic to transmit status information indicating whether the tag is affixed to a person.

9. The portable passenger tag as claimed in claim 8, wherein the circuit logic transmits status information only by exception, an exception being if the tag is not affixed to a person.

10. The portable passenger tag as claimed in claim 8, wherein the sensor is a temperature sensor.

11. The portable passenger tag as claimed in claim 1, wherein the transmitter transmits on one of a plurality of possible frequency channels and comprises means for being dynamically configured with a channel selection upon each use.

12. The portable passenger tag as claimed in claim 1, wherein the controller comprises logic for storing passenger boarding card data, and a security lock to prevent unauthorised editing of the boarding card data.

13. The portable passenger tag as claimed in claim 12, wherein the controller comprises logic for storing a passenger biometric as part of the boarding card data and an output interface for outputting biometric data.

14. The portable passenger tag as claimed in claim 13, wherein the biometric is a digital photograph.

15. The portable passenger tag as claimed in claim 13, wherein the controller comprises an erasing function for erasing all passenger-specific data upon receipt of a deactivation command.

16. The portable passenger tag as claimed in claim 1, wherein the controller monitors received time slot data and directs transmission by the wireless transmitter only in an allocated time slot.

17. The portable passenger tag as claimed in claim 16, wherein the controller directs transmission and reception in a cycle and powers down between cycles.

18. The portable passenger tag as claimed in claim 17, wherein the duty cycle is less than 1%.

19. The A passenger terminus communication system comprising:
a function in a check-in system for activating a tag of claim 1;
a plurality of transponders for receiving passenger identifiers transmitted by said tags;
a processor for receiving the identifiers from the transponders and for correlating them with passenger data, and for generating an alert if an alert condition is satisfied.

20. The A system as claimed in claim 19, wherein the processor determines passenger location on the basis of which transponder received a passenger's tag transmission.

21. The A passenger terminus communication system as claimed in claim 19, wherein the processor is in a server connected to the transponders via a network.

22. The A passenger terminus communication system as claimed in claim 19, wherein the transponders transmit data to the tags.

23. The A passenger terminus communication system as claimed in claim 22, wherein each transponder transmits data immediately in response to receiving a transmission from a tag.

24. The A passenger terminus communication system as claimed in claim 23, wherein each transponder allocates a time slot to each active tag, and indicates the time slot in each reply.

25. The A passenger terminus communication system as claimed in claim 19, wherein the tags and the transponders transmit at mutually different frequencies.

26. The A passenger terminus communication system as claimed in claim 19, wherein the transponders have a substantially longer transmission range than the tag transmitters.

27. The A passenger terminus communication system as claimed in claim 19, wherein the check-in function writes boarding card data to the tags, and the system further comprises a boarding gate function for reading said data and for de-activating the tags.

28. The A passenger terminus communication system as claimed in claim 19, wherein the check-in function comprises an interface for delivering a biometric of a passenger to the processor, and the boarding gate function comprises an interface for receiving and outputting the biometric.

29. The A passenger terminus communication system as claimed in claim 28, wherein the biometric is a photograph.
